(19) United States
(12) Patent Application Publication
(10) Pub. No.: US 2020/0146497 A1
(43) Pub. Date: May 14, 2020

(54) SLOW COOKER CAPABLE OF FRYING FOOD

(71) Applicant: Ningbo Jinyu Electric Appliance Co., Ltd., Yuyao City (CN)

(72) Inventors: Junda SHI, Yuyao City (CN); Zhongyu SHI, Yuyao City (CN); Shukuo LIU, Yuyao City (CN); Dong XIAO, Yuyao City (CN)

(73) Assignee: Ningbo Jinyu Electric Appliance Co., Ltd., Yuyao City (CN)

(21) Appl. No.: 16/247,812

(22) Filed: Jan. 15, 2019

(30) Foreign Application Priority Data
Nov. 12, 2018 (CN) 201811336830.6

(51) Int. Cl. A47J 27/00; A23L 5/10; A47J 37/06; A21B 1/24

(52) U.S. Cl. CPC A47J 27/004; A23L 5/12; A21B 1/245; A47J 37/0641; A23L 5/17

(57) ABSTRACT

The present invention discloses a slow cooker capable of frying food. The slow cooker includes a main body assembly, a ceramic inner container, a glass lid assembly and an airfryer head assembly, where the ceramic inner container is located inside the main body assembly, the glass lid assembly and the main body assembly are fitted to each other, the airfryer head assembly is fitted with the main body assembly, the glass lid assembly is used when the food is slowly stewed, and the airfryer head assembly used when the food is fried. By using the slow cooker of the present invention, it not only can realize slow stewing of food, but also can incorporate the function of food frying, thus realizing multi-purpose use of one machine.

This application claims priority to Chinese patent application number 201811336830.6, filed on 12 Nov. 2018, with a title of SLOW COOKER CAPABLE OF FRYING FOOD. The above-mentioned patent application is incorporated herein by reference in its entirety.

### TECHNICAL FIELD

The present invention relates to the technical field of slow cookers, and in particular to a slow cooker capable of frying food.

### BACKGROUND

With the development of society and the improvement of people's living standards, people's dietary requirements have also increased. A conventional slow cooker consists of a pot lid, a pot inner container and a pot shell, as well as a controller provided on a bottom surface of the pot shell, and has the following problems: it can only function for slowly stewing food and cannot realize the function of food frying.

### SUMMARY

The objective of the present invention is to provide a slow cooker capable of frying food, which not only can realize slow stewing of food, but also can incorporate the function of food frying, thus realizing multi-purpose use of one machine.

To achieve the above objective, the present invention provides the following solution:

A slow cooker capable of frying food preferably includes a main body assembly, a ceramic inner container, a glass lid assembly and an airfryer head assembly, where the ceramic inner container is preferably located inside the main body assembly, the glass lid assembly and the main body assembly are preferably fitted to each other, the airfryer head assembly is preferably fitted with the main body assembly, the glass lid assembly is used when the food is slowly stewed, and the airfryer head assembly is used when the food is fried.

Optionally, the airfryer head assembly includes a first socket, a sensor, a timing switch, a temperature controller, an electric motor, a heating tube, an upper fan blade and a lower fan blade therein, where an input end of the sensor is connected to a power source through the first socket, an output end of the sensor is connected to an input end of the timing switch, and an output end of the timing switch is connected to the temperature controller and the electric motor respectively, the temperature controller is connected to the heating tube, the heating tube is connected to the power source, the electric motor is connected to the power source, and an input end of the electric motor is connected to the upper fan blade and the lower fan blade respectively. Preferably, when the temperature of the heating tube reaches a set value of the temperature controller, the heating tube is powered off and the electric motor is not powered off, and the electric motor drives the upper fan blade and the lower fan blade to rotate, and when the heating time reaches a set time of the timing switch, the electric motor is powered off.

Optionally, the glass lid assembly includes a second socket, a rotary switch and a heating ring, where the rotary switch is a heating power switch which has adjustable gears of high, medium and low positions, the rotary switch is connected with the heating ring and the second socket respectively, the second socket is connected to the heating ring, and the heating ring is used for heating.

Optionally, the glass lid assembly is provided with a lid handle thereon.

Optionally, the airfryer head assembly is provided with an upper lid equipped with a handle and a lower lid equipped with a handle thereon.

Optionally, the slow cooker is also provided with a casing handle, the casing handle being disposed on the left and right sides of the main body assembly.

Optionally, the main body assembly is circular or elliptical in shape.

Optionally, the slow cooker further includes a metal inner container which is located outside the ceramic inner container.

The present invention discloses the following: the present invention provides a slow cooker capable of frying food, which preferably includes: a main body assembly, a ceramic inner container, a glass lid assembly and an airfryer head assembly, where the ceramic inner container is located inside the main body assembly, the glass lid assembly and the main body assembly are fitted to each other, the airfryer head assembly is fitted with the main body assembly, the glass lid assembly is used when the food is slowly stewed, and the airfryer head assembly is used when the food is fried. By using the slow cooker of the present invention, one can not only realize slow stewing of food, but also can incorporate the function of food frying, thus realizing multi-purpose use of one machine.

### BRIEF DESCRIPTION OF THE DRAWING

To describe the technical aspects of the present invention or in the prior art more clearly, the following briefly describes the accompanying drawings. The accompanying drawings in the following description show some embodiments of the present invention, and a person of ordinary skill in the art may still derive other drawings from these accompanying drawings without creative efforts.

FIG. 1 is a perspective view of a preferred embodiment of the present invention wherein the airfryer head assembly is being utilized on a slow cooker capable of frying food;

FIG. 2 is a perspective view of a preferred embodiment of the present invention wherein the glass lid assembly is being utilized on a slow cooker capable of frying food;

FIG. 3 is a schematic diagram showing the connection relationship of the internal components of the airfryer head assembly according to preferred embodiments of the present invention;

FIG. 4 is a schematic diagram showing the connection relationship of the internal components of the airfryer head assembly according to preferred embodiments of the present invention;

FIG. 5 is an exploded diagram of components of an airfryer head assembly which can be utilized when food frying is desired; and

FIG. 6 is an exploded diagram of components of a slow cooker capable of frying food wherein a glass lid assembly is utilized.

### DETAILED DESCRIPTION

The following describes the present invention with reference to the accompanying drawings. The described embodiments are merely a part rather than all of the embodiments of the present invention. All other embodiments obtained by a person of ordinary skill in the art based on the embodiments of the present invention without creative efforts shall fall within the protection scope of the present invention.

The objective of the present invention is to provide a slow cooker capable of frying food, which not only can realize slow stewing of food, but also can incorporate the function of food frying, thus realizing multi-purpose use of one machine.

To make the foregoing objective, features, and advantages of the present invention clearer and more comprehensible, the present invention is further described in detail below with reference to the accompanying drawings and preferred embodiments.

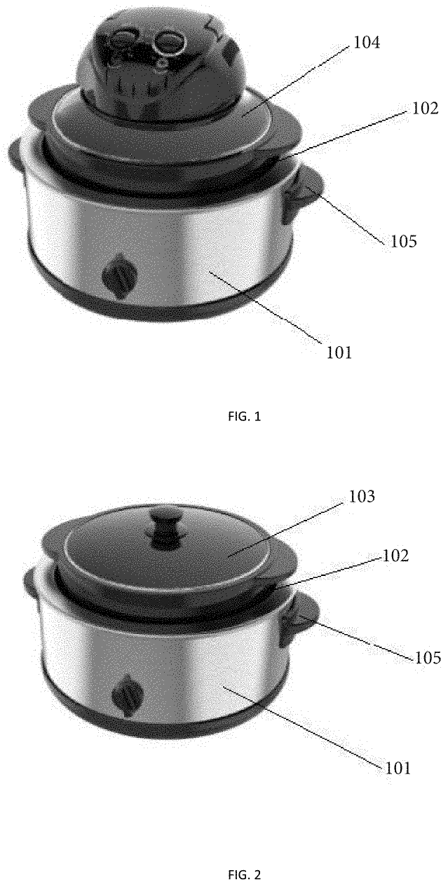

FIG. 1 is a perspective view of a preferred embodiment of the present invention wherein the airfryer head assembly is being utilized on a slow cooker capable of frying food. FIG. 2 is a perspective view of a preferred embodiment of the present invention wherein the glass lid assembly is being utilized on a slow cooker capable of frying food. A slow cooker capable of frying food is shown in FIGS. 1 and 2. The slow cooker includes a main body assembly 101, a ceramic inner container 102, a glass lid assembly 103 and an airfryer head assembly 104, where the ceramic inner container 102 is located inside the main body assembly 101, the glass lid assembly 103 and the main body assembly 101 are fitted to each other, the airfryer head assembly 104 is fitted with the main body assembly 101, the glass lid assembly 103 is used when the food is slowly stewed, and the airfryer head assembly 104 used when the food is fried.

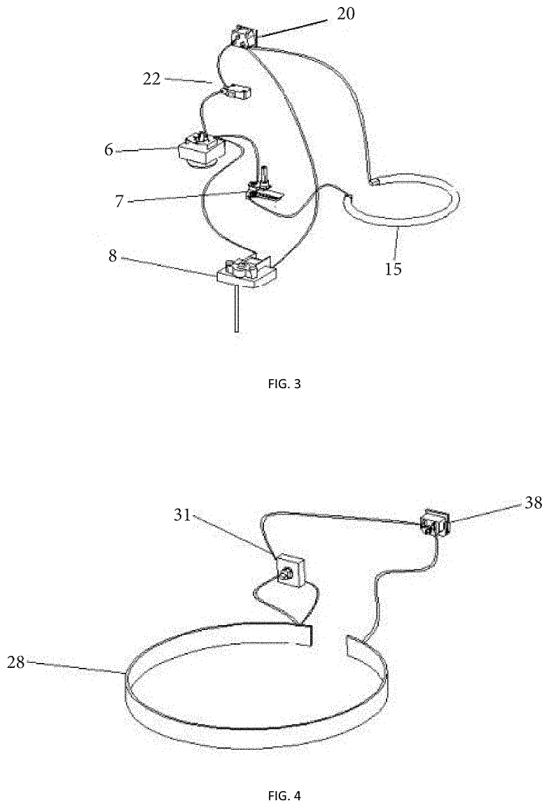

The airfryer head assembly 104 includes a first socket, a sensor, a timing switch, a temperature controller, an electric motor, a heating tube, an upper fan blade and a lower fan blade therein, where an input end of the sensor is connected to a power source through the first socket, an output end of the sensor is connected to an input end of the timing switch, and an output end of the timing switch is connected to the temperature controller and the electric motor respectively, the temperature controller is connected to the heating tube, the heating tube is connected to the power source, the electric motor is connected to the power source, and an input end of the electric motor is connected to the upper fan blade and the lower fan blade respectively; when the temperature of the heating tube reaches a set value of the temperature controller, the heating tube is powered off and the electric motor is not powered off, and the electric motor drives the upper fan blade and the lower fan blade to rotate, and when the heating time reaches a set time of the timing switch, the electric motor is powered off. FIG. 3 is a schematic diagram showing the connection relationship of the internal components of the airfryer head assembly according to preferred embodiments of the present invention. The airfryer head assembly 104 is provided with an upper lid equipped with a handle and a lower lid equipped with a handle thereon.

The glass lid assembly 103 includes a second socket, a rotary switch and a heating ring, where the rotary switch is a heating power switch which has adjustable gears of high, medium and low positions, the rotary switch is connected with the heating ring and the second socket respectively, the second socket is connected to the heating ring, and the heating ring is used for heating. FIG. 4 is a schematic diagram showing the connection relationship of the internal components of the glass lid assembly according to preferred embodiments of the present invention. The glass lid assembly 103 is provided with a lid handle thereon.

The slow cooker is also provided with a casing handle 105, the casing handle being disposed on the left and right sides of the main body assembly. The main body assembly is preferably circular or elliptical in shape. The slow cooker further includes a metal inner container which is located outside the ceramic inner container 102.

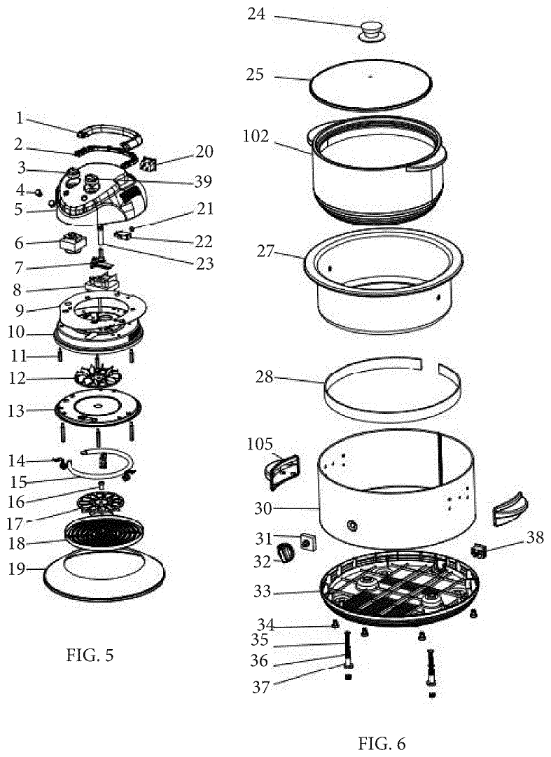

FIG. 5 is an exploded diagram of an airfryer head assembly which can be utilized when food frying is desired. The airfryer head assembly 104 may be comprised of a glass cover 19 which contains an opening for air-outlet disk 18 which is positioned under lower fan blade 17. The airfryer head assembly includes a first socket 20, a sensor 22, a timing switch 6, a temperature controller 7, an electric motor 8, a heating tube 15, an upper fan blade 12 and a lower fan blade 17 therein, where an input end of the sensor 22 is connected to a power source through the first socket 20, an output end of the sensor 22 is connected to an input end of the timing switch 6, and an output end of the timing switch 6 is connected to the temperature controller 7 and the electric motor 8 respectively, the temperature controller 7 is connected to the heating tube 15, the heating tube 15 is connected to the power source, the electric motor 8 is connected to the power source, and an input end of the electric motor 8 is connected to the upper fan blade 12 and the lower fan blade 17 respectively. When the temperature of the heating tube 15 reaches a set value of the temperature controller 7, the heating tube 15 is powered off and the electric motor 8 is not powered off, and the electric motor 8 drives the upper fan blade 12 and the lower fan blade 17 to rotate, and when the heating time reaches a set time of the timing switch 6, the electric motor 8 is powered off.

The heating tube 15 is mounted utilizing a heating-tube mounting bracket 14. The airfryer head assembly further comprises a baffle plate 13, an upper supporting disk 10, a thermal insulation sheet 9, multiple screw posts 11, a supporting column 16, a microswitch 21, a connection column 23, a main body 5, an indicator-lamp cover 4, a knob 3 on the main body 101, a temperature control knob 39, a lower lid equipped with a handle 2 and an upper lid equipped with a handle 1.

FIG. 6 is an exploded diagram of a slow cooker capable of frying food wherein a glass lid assembly is utilized. Retaining brackets 37, nuts 36, and screws 35 are utilized to secure the bottom lid 33 to the aluminum inner container 27. Multiple foot pads 34 are attached to the underside of bottom lid 33. A socket 38, rotary switch 31, and heating ring 28 are included in the glass lid assembly 103. The slow cooker is also provided with a casing handle 105, the casing handle attaching to the casing 30 and being disposed on the left and right sides of the main body assembly. Ceramic inner container 102 sits on top of aluminum inner container 27. When the glass lid assembly 103 is placed onto the ceramic inner container 102, food stewing is enabled by adjusting a knob 32 on the main body assembly 101 among three gear positions. The glass lid assembly 103 is provided with a glass lid 25 and lid handle 24 thereon.

The present invention has the following functions:

Function of airfryer: food frying is enabled by putting the airfryer head assembly 104 onto the ceramic inner container 102, where a timing switch can adjust a time-controlled power source, and a temperature control knob can adjust the temperature controller; and

Function of slow cooker: the airfryer head assembly is removed and the glass lid assembly 103 is placed onto the ceramic inner container 102, and then food stewing is enabled by adjusting a knob on the main body assembly 101 among three gear positions.

By using the slow cooker of the present invention, one can not only realize slow stewing of food, but also can incorporate the function of food frying, thus realizing multi-purpose use of one machine.

Parts List

| | |
|---|---|
| 1 | upper lid equipped with a handle |
| 2 | lower lid equipped with a handle |
| 3 | knob on the main body |
| 4 | indicator-lamp cover |
| 5 | main body |
| 6 | timing switch |
| 7 | temperature controller |
| 8 | electric motor |
| 9 | thermal-insulation sheet |
| 10 | upper supporting disk |
| 11 | screw post |
| 12 | upper fan blade |
| 13 | baffle plate |
| 14 | heating-tube mounting bracket |
| 15 | heating tube |
| 16 | supporting column |
| 17 | lower fan blade |
| 18 | air-outlet disk |
| 19 | glass cover |
| 20 | socket |
| 21 | microswitch |
| 22 | sensor |
| 23 | connection column |
| 24 | lid handle |
| 25 | glass lid |
| 27 | aluminum inner container |
| 28 | heating ring |
| 30 | casing |
| 31 | rotary switch |
| 32 | knob |
| 33 | bottom lid |
| 34 | foot pad |
| 35 | screw |
| 36 | nut |
| 37 | retaining bracket |
| 38 | socket |
| 39 | temperature control knob |
| 101 | main body assembly |
| 102 | ceramic inner container |
| 103 | glass lid assembly |
| 104 | airfryer head assembly |
| 105 | casing handle |

Each embodiment of the present specification is described in a progressive manner, each embodiment focuses on the difference from other embodiments, and the same and similar parts between the embodiments may refer to each other.

Several examples are used for illustration of the principles and implementation methods of the present invention. The description of the embodiments is used to help illustrate the system and its core principles of the present invention. In addition, those skilled in the art can make various modifications in terms of specific embodiments and scope of application in accordance with the teachings of the present invention. In conclusion, the content of this specification shall not be construed as a limitation to the invention.

What is claimed is:

1. A slow cooker capable of frying food, comprising a main body assembly, a ceramic inner container, a glass lid assembly and an airfryer head assembly, wherein the ceramic inner container is located inside the main body assembly, the glass lid assembly and the main body assembly are fitted to each other, the airfryer head assembly is fitted with the main body assembly, the glass lid assembly is used when the food is slowly stewed, and the airfryer head assembly used when the food is fried.

2. The slow cooker capable of frying food according to claim 1, wherein the airfryer head assembly comprises a first socket, a sensor, a timing switch, a temperature controller, an electric motor, a heating tube, an upper fan blade and a lower fan blade therein, wherein an input end of the sensor is connected to a power source through the first socket, an output end of the sensor is connected to an input end of the timing switch, and an output end of the timing switch is connected to the temperature controller and the electric motor respectively, the temperature controller is connected to the heating tube, the heating tube is connected to the power source, the electric motor is connected to the power source, and an input end of the electric motor is connected to the upper fan blade and the lower fan blade respectively; when the temperature of the heating tube reaches a set value of the temperature controller, the heating tube is powered off and the electric motor is not powered off, and the electric motor drives the upper fan blade and the lower fan blade to rotate; and when a heating time reaches a set time of the timing switch, the electric motor is powered off.

3. The slow cooker capable of frying food according to claim 1, wherein the glass lid assembly comprises a second socket, a rotary switch and a heating ring, wherein the rotary switch is a heating power switch which has adjustable gears of high, medium and low positions, the rotary switch is connected with the heating ring and the second socket respectively, the second socket is connected to the heating ring, and the heating ring is used for heating.

4. The slow cooker capable of frying food according to claim 1, wherein the glass lid assembly is provided with a lid handle thereon.

5. The slow cooker capable of frying food according to claim 1, wherein the airfryer head assembly is provided with an upper lid equipped with a handle and a lower lid equipped with a handle thereon.

6. The slow cooker capable of frying food according to claim 1, wherein the slow cooker is also provided with a casing handle, the casing handle being disposed on left and right sides of the main body assembly.

7. The slow cooker capable of frying food according to claim 1, wherein the main body assembly is circular or elliptical in shape.

8. The slow cooker capable of frying food according to claim 1, wherein the slow cooker further comprises a metal inner container which is located outside the ceramic inner container.

9. A slow cooker capable of frying food, comprising a main body assembly, a ceramic inner container, an airfryer head assembly, wherein the ceramic inner container is located inside the main body assembly, the airfryer head assembly is fitted with the main body assembly, and the airfryer head assembly used when the food is fried.

10. The slow cooker capable of frying food according to claim 9, wherein the airfryer head assembly comprises a first socket, a sensor, a timing switch, a temperature controller, an electric motor, a heating tube, an upper fan blade and a lower fan blade therein, wherein an input end of the sensor is connected to a power source through the first socket, an output end of the sensor is connected to an input end of the timing switch, and an output end of the timing switch is connected to the temperature controller and the electric motor respectively, the temperature controller is connected to the heating tube, the heating tube is connected to the power source, the electric motor is connected to the power source, and an input end of the electric motor is connected to the upper fan blade and the lower fan blade respectively; when the temperature of the heating tube reaches a set value of the temperature controller, the heating tube is powered off and the electric motor is not powered off, and the electric motor drives the upper fan blade and the lower fan blade to rotate; and when a heating time reaches a set time of the timing switch, the electric motor is powered off.

11. The slow cooker capable of frying food according to claim 9, wherein the airfryer head assembly is provided with an upper lid equipped with a handle and a lower lid equipped with a handle thereon.

12. The slow cooker capable of frying food according to claim 9, wherein the slow cooker is also provided with a casing handle, the casing handle being disposed on left and right sides of the main body assembly.

13. The slow cooker capable of frying food according to claim 9, wherein the main body assembly is circular or elliptical in shape.

14. The slow cooker capable of frying food according to claim 9, wherein the slow cooker further comprises a metal inner container which is located outside the ceramic inner container.

15. An airfryer head assembly for use with a slow cooker capable of frying food, the slow cooker comprising a main body assembly, a ceramic inner container, wherein the ceramic inner container is located inside the main body assembly, the airfryer head assembly is fitted with the main body assembly, and the airfryer head assembly used when the food is fried.

16. The airfryer head assembly according to claim 15, wherein the airfryer head assembly comprises a first socket, a sensor, a timing switch, a temperature controller, an electric motor, a heating tube, an upper fan blade and a lower fan blade therein, wherein an input end of the sensor is connected to a power source through the first socket, an output end of the sensor is connected to an input end of the timing switch, and an output end of the timing switch is connected to the temperature controller and the electric motor respectively, the temperature controller is connected to the heating tube, the heating tube is connected to the power source, the electric motor is connected to the power source, and an input end of the electric motor is connected to the upper fan blade and the lower fan blade respectively; when the temperature of the heating tube reaches a set value of the temperature controller, the heating tube is powered off and the electric motor is not powered off, and the electric motor drives the upper fan blade and the lower fan blade to rotate; and when a heating time reaches a set time of the timing switch, the electric motor is powered off.

17. The slow cooker capable of frying food according to claim 15, wherein the airfryer head assembly is provided with an upper lid equipped with a handle and a lower lid equipped with a handle thereon.

18. The slow cooker capable of frying food according to claim 15, wherein the slow cooker is also provided with a casing handle, the casing handle being disposed on left and right sides of the main body assembly.

19. The slow cooker capable of frying food according to claim 15, wherein the main body assembly is circular or elliptical in shape.

20. The slow cooker capable of frying food according to claim 15, wherein the slow cooker further comprises a metal inner container which is located outside the ceramic inner container.
